(19) United States
(12) Patent Application Publication
(10) Pub. No.: US 2012/0229896 A1
(43) Pub. Date: Sep. 13, 2012

(54) LENTICULAR ARRAY INTENDED FOR AN AUTOSTEREOSCOPIC SYSTEM

(75) Inventor: Pierre Allio, Paris (FR)

(73) Assignee: ALIOSCOPY, PARIS (FR)

(21) Appl. No.: 13/180,014

(22) Filed: Jul. 11, 2011

(30) Foreign Application Priority Data
Mar. 9, 2011 (FR) 11 00700

(51) Int. Cl. G02B 27/22

(52) U.S. Cl. 359/463

(57) ABSTRACT

The invention relates to a lenticular array intended to be placed in front of a screen so as to carry out autostereoscopic viewing and comprising lenticules separated by a spacing P and extending in a longitudinal direction and which are joined together via a longitudinal principal join line, characterized in that each micro-lens is comprised of at least N′ contiguous plane faces which are joined together via a longitudinal secondary join line with N′ greater than or equal to 2, each plane face defining in cross-section perpendicular to the said longitudinal direction a straight segment, and in that the ends of the said straight segments are situated on a circular arc centred on a point O situated in the mid-plane of the said micro-lens, or else on a portion of parabola, hyperbola or ellipse with focus (F) situated in the said mid-plane (MP).

### FIELD OF THE INVENTION

The subject of the present invention is a lenticular array intended for an autostereoscopic system.

### BACKGROUND

Two techniques are known which allow relief viewing without spectacles on the basis of a screen.

The first technique, which is the oldest, is that of the parallax barrier which is stuck in front of the screen at a precise distance from it. The principal drawback of this technique, which means that it is practically never used any longer, is its low brightness, since each eye receives only 1/N^{th} of the luminous information, N denoting the number of viewpoints of the autostereoscopic image.

The second technique which is commonly employed is that of the lenticular array, which is a transparent plate consisting of cylindrical micro-lenses of focal length f.

The lenticular array may be placed so as to overlap, either in a first case, a plurality of pixels of the screen (each of which is composed of p sub-pixels), or in a second case, a plurality of sub-pixels of the screen as for example in PCT application WO 94/26072, European patent EP 1106016, or else in European patent EP 1779181. In either case, the micro-lenses may be disposed parallel to the pixel columns of the screen (which have vertical axis), or else by having their longitudinal axis inclined with respect to the columns of pixels of the screen.

The adjoining cylindrical micro-lenses behave in the horizontal direction like so many small objectives.

A cylindrical lens having a focal length f is placed in proximity to the plane of the screen and dimensioned so that the field of the object space (equal to N times the interocular gap of 6.5 cm) considered at a distance equal to L (flat tint distance) forms an image whose width is N sub-pixels (N denoting the number of viewpoints).

For a plane-convex type cylindrical lens, we conventionally have f=R/(n−1), R denoting the radius of the micro-lens and n the index of the material of the micro-lens (which is, in practice, about 1.4), thus giving f˜2.5 F.

Example: N=8, p=3, L=4 m, f=14 mm. Screen 40 inches in diagonal with 1920×1980 pixels.

In this specific case, each lens forms an image of 8 sub-pixels, i.e. 2 pixels 2/3.

The spacing of the adjoining lenses (all identical) and their positioning with respect to the screen is calculated so that the axes passing through the optical centres of each micro-lens converge at 4 m if they originate from one of the sub-pixels (modulo N=8). Thus, an eye, placed 4 m away, sees through the optical component just one of the 8 sub-pixels modulo 8, over the whole screen. This corresponds to the flat tint. Indeed, if the displayed image consists of an imbrication of sub-pixels, in circular permutation, of 8 viewpoints, then, at this particular distance, an eye will be able to perceive only one of these viewpoints whose sub-pixels, which represent the totality thereof used, are optically widened by a factor 8 by the magnifying glass effect. Thus, the image forms a continuous optical surface.

At the flat tint distance, the eye passes from one viewpoint to the next viewpoint by horizontal movement of 6.5 cm (inter-ocular space).

When the eye moves 52 cm horizontally (6.5×N=52 cm for N=8), it perceives, every 6.5 cm, another sub-pixel modulo 8 and consequently another viewpoint on the whole screen. There is therefore a perfect relationship between the movement of the eye and the observation of the surface of the screen. It may be said that the eye scans the surface of the screen while moving by virtue of the micro-lenticular array.

When the eye moves 0.65 cm, it has scanned only a tenth of the surface of the sub-pixels modulo 8. If the sub-pixels exhibit significant variations in brightness because their structure is not continuous and homogeneous, and because the frosted overlay optionally covering the surface of the screen is not sufficiently diffusing, then during its travel of 6.5 cm the eye perceives proportional variations in the brightness of the screen, this constituting a serious impairment of quality.

When the observer gets nearer to the screen or further away from it (that is to say the observer is no longer at the flat tint distance), the brightness variations of the sub-pixels generate so-called magnification moire patterns which exhibit ever-more closely spaced fringes. Each quasi-vertical band of moire patterns consists of the sub-pixels allocated to a viewpoint.

Now, the recomposition of the perceived image is one of the positive major effects of autostereoscopy provided that moire patterns are not detrimental to this optical, geometrical and psychophysiological phenomenon.

### SUMMARY

The subject of the present invention is a lenticular array which makes it possible to at least partially suppress these moire patterns, while avoiding a noticeable loss of brightness.

The invention thus relates to a lenticular array intended to be placed in front of a screen so as to carry out autostereoscopic viewing and comprising lenticules separated by a spacing P and extending in a longitudinal direction, the lenticules being joined together via a longitudinal principal join line, characterized in that each micro-lens is comprised of at least N′ contiguous plane faces which are joined together via a longitudinal secondary join line with N′ greater than or equal to 2, each plane face defining in cross-section perpendicular to the said longitudinal direction a straight segment, with a longitudinal axis, and in that the ends of the said straight segments are situated on a circular arc centred on a point O situated in a mid-plane MP of the said micro-lens, or else on a portion of conic (parabola, hyperbola or ellipse) having its focus(foci) F situated in the said mid-plane MP.

The N′ straight segments preferably have the same length.

The lenticular array with prismatic faces according to the invention can be substituted for an axisymmetric cylindrical lenticular array whose lenticules exhibit in cross-section the said circular arc centred at the said point O.

On account of the presence of the straight segments, the field of the lenticules remains the same, but a sub-pixel of the image displayed on the screen is no longer seen by an observer with a magnification, but it is on the contrary duplicated N′ times, as will be shown subsequently in the description.

The invention also relates to a device for displaying an autostereoscopic image with N viewpoints, characterized in that it comprises a lenticular array such as defined hereinabove.

An optimal result is obtained when N′=N, N denoting the number of viewpoints of the autostereoscopic image to be displayed, but it is possible to choose N′ less than or greater than N, as will be specified subsequently in the description.

### BRIEF DESCRIPTION OF THE DRAWINGS

Other characteristics and advantages of the invention will become more apparent on reading the description hereinafter, in conjunction with the drawings in which:

FIG. 1 illustrates the case of a liquid crystal screen whose sub-pixels exhibit inhomogeneities of illumination; on the left of the drawing is depicted a photo of a sub-pixel of this type, illuminated over the whole of its surface;

FIGS. 2a and 2b (FIG. 8a of Patent EP 1 779 181) illustrate a lenticular array according to the prior art and its implementation in the case where N=8; on the left of FIG. 8b is depicted a screen photo corresponding to this case;

FIGS. 3a (cross-section perpendicular to the longitudinal direction of the micro-lenses, which here is inclined with respect to the vertical direction) and 3b illustrate a lenticular array according to the present invention and its implementation in the same case as previously (N=8); on the left of FIG. 3b is depicted a screen photo corresponding to this case; FIG. 3c is a variant of FIG. 3a corresponding to the replacement of a lenticular array having a hyperbolic, parabolic or elliptical profile with an array according to the invention.

FIGS. 4a and 4b are optical diagrams respectively illustrating the prior art and the invention.

FIGS. 5a to 5d are photos corresponding to a lighting of the screen of the type represented in FIG. 1 by a uniform grey patch (of level 50%) at a distance of 1 m (FIGS. 5a and 5b), and of 8 m (FIGS. 5c and 5d); FIGS. 5a and 5c correspond to the prior art (conventional lenticular array), and FIGS. 5b and 5d to a screen equipped with an array according to the invention.

### DETAILED DESCRIPTION

Screen manufacturers are tending to increase both the contrast and the lateral and vertical angle of observation of the screen.

With this aim, in many liquid crystal screens (LCD), each sub-pixel comprises two zones, a first zone 1 (which may be split into zones 1₁, 1₂, 1₃) and which lights up for low illumination levels, up to a threshold chosen by the constructor, and a second zone 2 (which may be split into zones 2₁, 2₂) which lights up in addition to the first zone when the illumination that must be provided by the sub-pixel exceeds the chosen threshold.

This sub-division of the sub-pixels which makes it possible to increase the contrast of the screen creates by nature a lack of homogeneity of the illumination on the surface of the sub-pixel.

An observer who looks directly at the screen (reproduction of flat images) does not perceive, at the customary observation distance for which a sub-pixel of width 0.15 mm is seen at a distance of 4 metres, this sub-division of the sub-pixels, and the latter are perceived as a zone of homogeneous illumination.

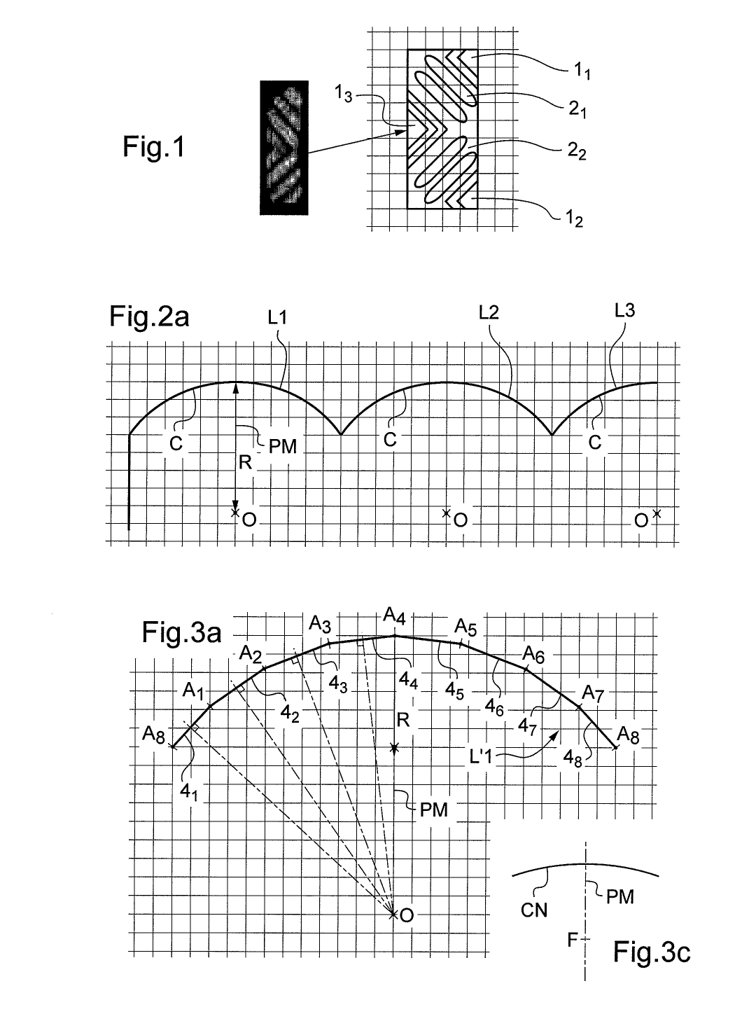

To increase the angle of vision in the horizontal and vertical directions, provision is also made for the first and the second zone to present chevrons inclined for example at +45° and chevrons inclined for example by −45° with respect to the vertical. In the example of FIG. 1, the secondary zones 1₁, 1₂, 1₃, 2₁ and 2₂ comprise chevrons thus inclined.

This creates an additional inhomogeneity of the illumination of the sub-pixel, but as previously, during the reproduction of flat images, the observer does not perceive this inhomogeneity at the customary viewing distance.

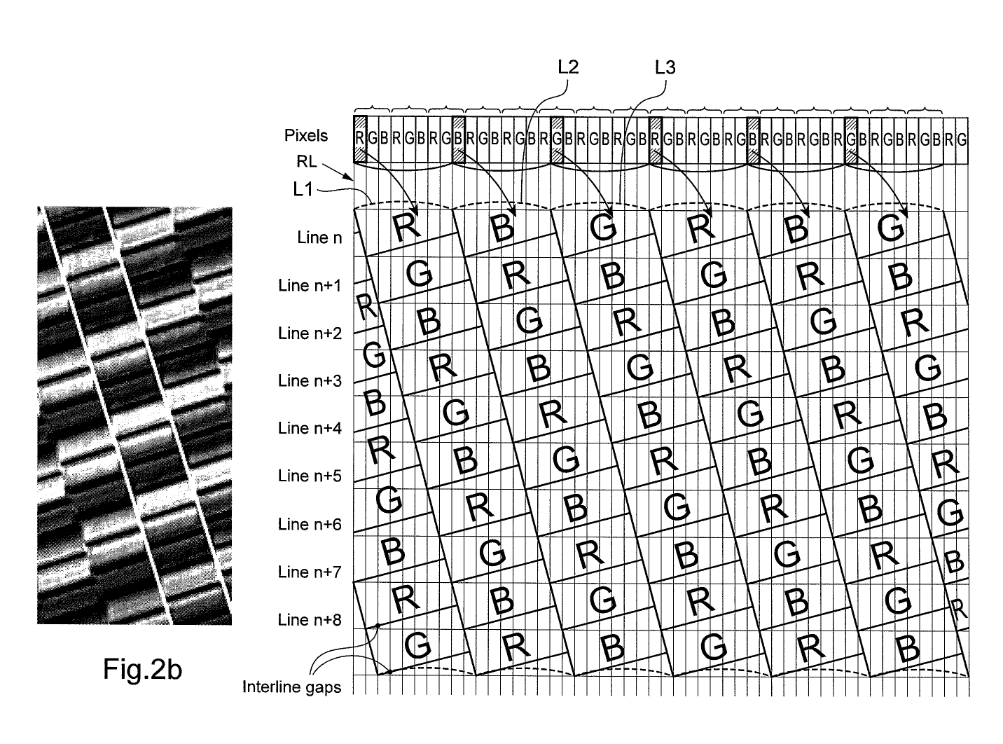

This example uses a conventional lenticular array, shown in cross-section in FIG. 2a, perpendicular to the longitudinal direction of the micro-lenses, which lenticular array comprises cylindrical micro-lenses of circular section (L₁, L₂, L₃, . . . ) with radius R having a plane face disposed at a given distance from the screen, the longitudinal axis of the micro-lenses being inclined with respect to the vertical direction of the screen, in order to view autostereoscopic images. Each micro-lens (L₁, L₂, L₃, . . . ) traces in section a circular arc of radius R whose centre O is situated in a longitudinal mid-plane MP. Each sub-pixel is enlarged by a factor N so as to be seen by the observer at the flat tint distance in such a way that the sub-pixels of the adjacent viewpoints join up and that the observed image is continuous.

FIG. 2b (which is FIG. 8a of European patent EP 1779181) shows this.

In this figure which corresponds to the case where N=8 and to viewpoint No. 1, seen by an eye of an observer, it is seen that the red R, green G and blue B sub-pixels (that have been picked out in grey for the case of line n, for the understanding of the demonstration) are magnified eight times and each sub-pixel is seen by an observer as occupying the width of a micro-lens of the inclined lenticular array which overlaps N sub-pixels, namely, for line n and viewpoint No. 1, the successive sub-pixels R, B, G, R, B, G, etc.

Thus, with a lenticular array such as this, the sub-pixel is magnified N times, just like its illumination inhomogeneities, and its width goes from 0.15 mm on the screen (in the aforementioned example) to 1.2 mm.

As in the screens of this type, manufacturers are tending to eliminate frosted surfaces (which induce a loss of brightness), the inhomogeneities of illumination of sub-pixels are fully amplified by the lenticular array.

The consequences are explained hereinbelow:

The N sub-pixels dispatch light which fills space in a continuous manner if the sub-pixels are continuous. Everything happens as if the observer were able to very finely scan the surface of the screen through the lenticular array. Indeed, the size of the pupil of the observer's eye is very small with respect to the inter-ocular distance, it therefore receives only a small part of the light emitted by a sub-pixel and passing through a micro-lens.

Horizontally the eye must scan a segment equal to the width of a lobe/N (namely 65 mm at the flat tint distance L), in order to have observed successively, for a given height, all of the light emitted by a sub-pixel and passing through the said micro-lens. When the observer's pupil has travelled the inter-ocular distance (65 mm) horizontally, it receives the light arising from the immediately adjacent sub-pixel. If the horizontal movement was towards the left, it is the sub-pixel to the right of the previous one that it sees, and so on and so forth, until the end of the lobe. If the inter-ocular space considered is equal to 65 mm, and the sub-pixel is 0.150 mm wide, then when the observer has moved by 65 mm, i.e. 1/N times the width of the lobe, he has scanned 0.150 mm of the surface of the screen.

If the sub-pixel is overlapped by a frosted surface which homogenizes the emitted light, then the luminous segment that it produces is homogeneous, and if the frosting is weak, or indeed nonexistent, and the sub-pixel exhibits a luminous surface consisting of very different (variable) brightness sub-parts as in the example hereinabove, the observer's pupil receives, during its horizontal displacement of 65 mm towards the right or towards the left, light which varies in the same proportions and the same rhythm.

At the flat tint distance L, the perceptible effects are due to the magnification in a ratio N of the inhomogeneities, and remain relatively acceptable, on condition that the observer remains stationary.

When the observer deviates from the flat tint distance L, the consequences are particularly disastrous. Vertical moire patterns then appear, composed of an alternation of half-bright half-dark bands inside each lobe. The number of bands grows as the observer deviates from the flat tint distance L, whether he is getting nearer or further away. This number of bands tends to N for an observation distance substantially equal to half or double the flat tint distance L.

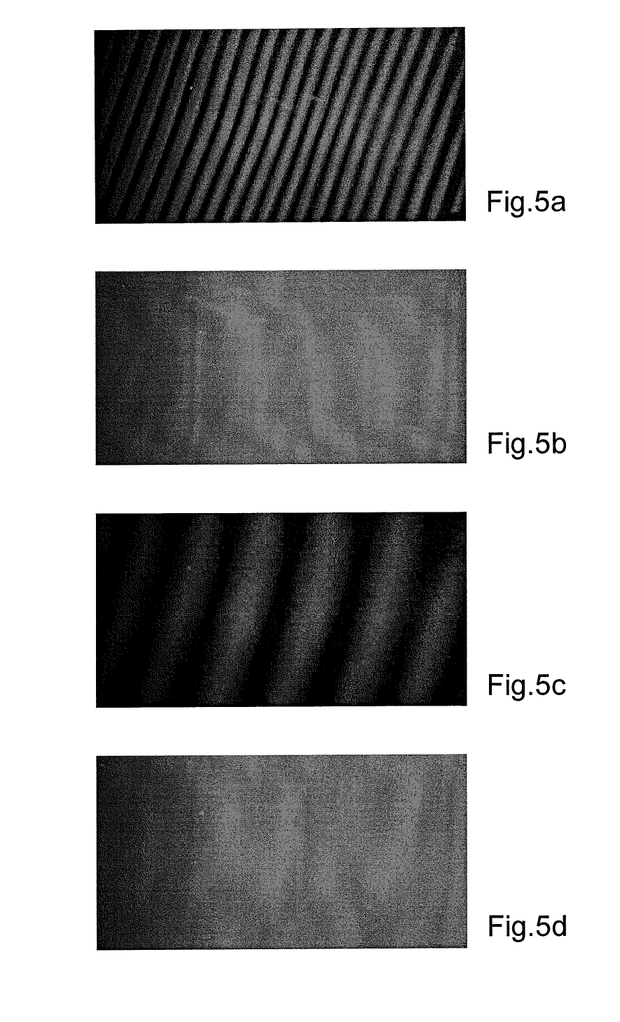

FIGS. 5a and 5c show moire patterns at an observation distance of respectively 1 m and 8 m from the screen for a flat tint distance L=4 m and N=8. The screen has been illuminated by a uniform grey patch of intensity 50%, which does not light up all the zones of the sub-pixels of FIG. 1.

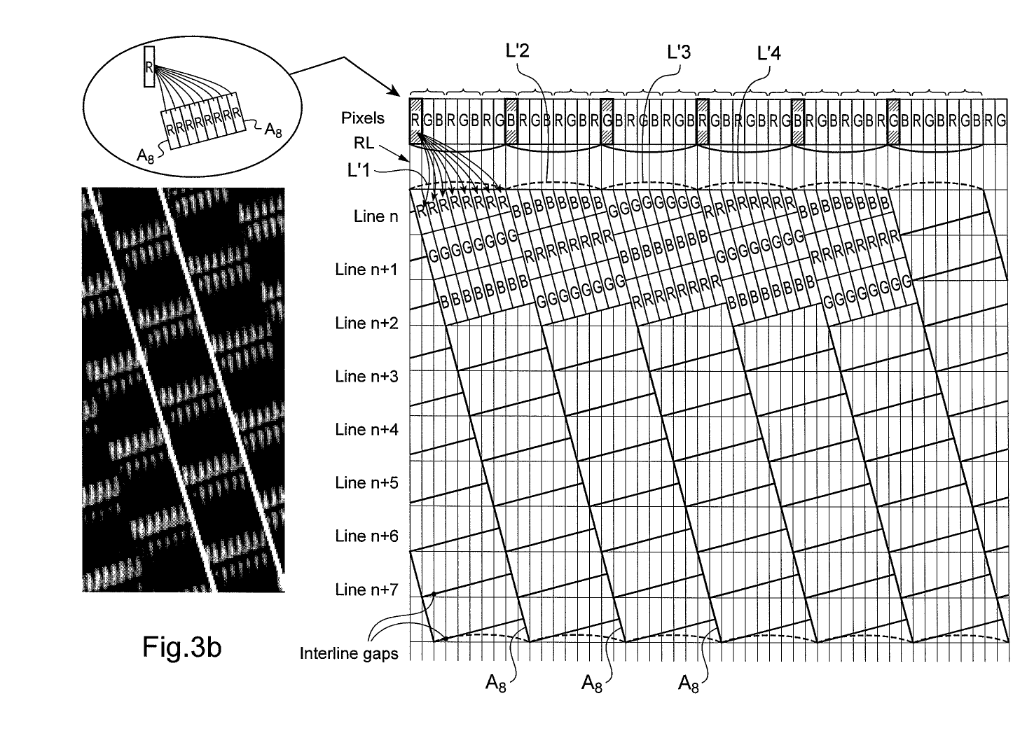

According to the invention, the cylindrical micro-lenses L₁, L₂, L₃ whose section is a circle sector are replaced (FIG. 3a) with cylindrical micro-lenses L′₁, L′₂, L′₃ . . . having the same axis, whose section consists of facets, preferably equal to N in number. These facets 4₁, 4₂ . . . 4₈ in the example of FIG. 3a which relates to a lenticular array that can substitute for the lenticular array of FIG. 2a, join up at points A₁, A₂, A₃ . . . A₈ (for N′=8), the point A₈ being common to two adjacent micro-lenses.

The segments A₁A₂, A₂A₃ . . . A₇A₈ of the facets 4₁, 4₂ . . . 4₈ . . . of each micro-lens preferably have the same length l and the distances OA₁, OA₂, OA₃ . . . OA₈ are all equal to the value of the radius R. The medians of segments A₁A₂, A₂A₃ . . . A₇A₈ cut one another at the point O, whether or not the segments have the same length. The centre O is situated in the mid-plane of the micro-lens.

Stated otherwise, and all other things being equal, the circular arcs with centre O of the cross-sections of the micro-lenses are replaced by N prismatic facets whose join points are situated at the distance R from the point O, R being the radius of the circular arc C corresponding to the micro-lenses of FIG. 2a.

A lenticular array is thus replaced by a prismatic array whose facets join up at points A₁ . . . A₈ situated on the circular arcs C of the lenticules L₁, L₂ . . . of the lenticular array of FIG. 2a.

FIG. 3b shows by comparison with FIG. 2b, that the sub-pixels are no longer magnified (because of the presence of the prismatic faces), but are duplicated N times without magnification. Therefore, neither are the inhomogeneities of the brightness magnified, thus making it possible to avoid the presence of troublesome moire patterns as was the case with a lenticular array (FIG. 2a).

The variant of FIG. 3c differs from that of FIG. 3a through the fact that the points A₁ . . . A_{N′} are situated on an arc CN of a conic (hyperbola, parabola or ellipse) whose focus is in the mid-plane of the micro-lens.

FIGS. 5b and 5d correspond respectively to the cases of FIGS. 5a and 5c, on replacing the lenticular array of the prior art with an array according to the invention with N′=8 facets, all other things being equal. It is seen that the moire patterns have almost totally disappeared in favour of a grey quasi-patch. On a real image displayed on the screen, they are now practically imperceptible.

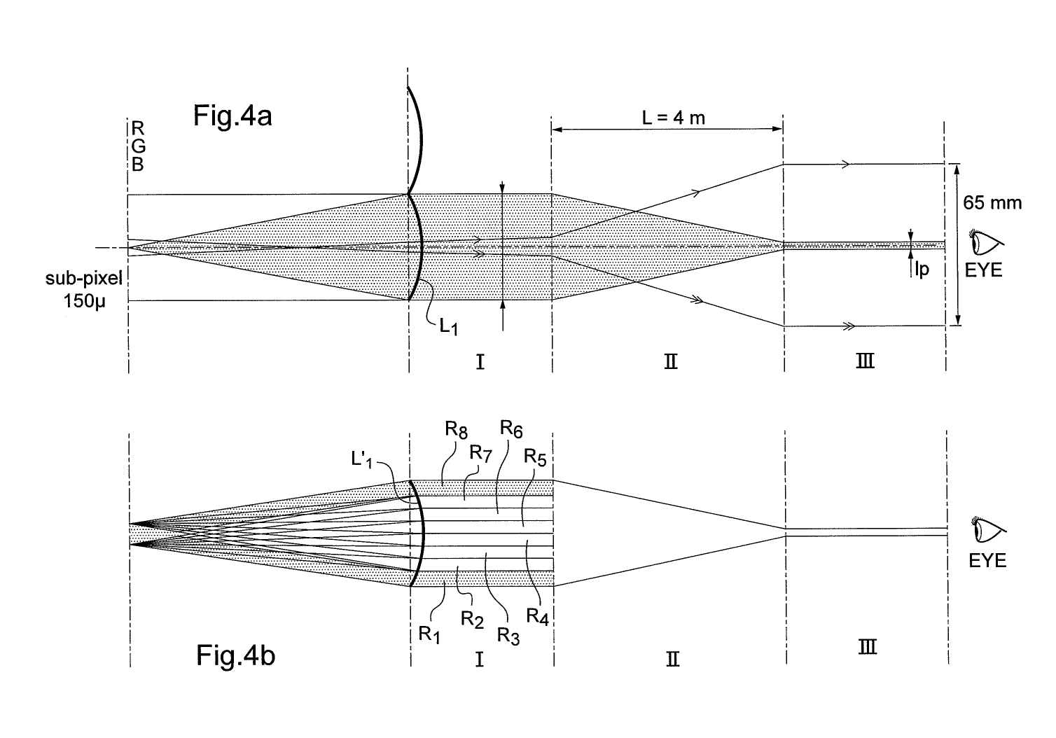

FIGS. 4a and 4b illustrate the difference between the two micro-lenses.

Because of the small size of the sub-pixels (typically 0.15 mm) and of the flat tint distance L for a contemporary screen (about 4 m) the left part I (proximity of the micro-lenses) and the right part III (proximity of the pupil) of each of FIGS. 4a and 4b have been considerably amplified, whereas the central part II (propagation up to the vicinity of the flat tint distance L) has been greatly reduced, the effect of which is to greatly accentuate the angle of the cone of convergence of the rays in the central part II, whereas the rays which reach the eye are practically parallel on account of the value (four metres) of the observation distance L.

In FIG. 4a (prior art), the micro-lens “sees” a sub-pixel (hatched zone) and this sub-pixel is in its turn seen by the pupil of the eye of width 1ₚ.

In FIG. 4b, and for the same position of the eye, the same sub-pixel is seen without enlargement by the eye through each facet of the prismatic micro-lens, and it is therefore eight replicas R₁ to R₈ of this sub-pixel which are seen without being enlarged by the pupil of the eye.

Indeed, the micro-lens which comprises eight facets of the same width remains facing eight sub-pixels, and consequently, a facet of width 1 “sees” one of the sub-pixels.

As the segments of facets of the micro-lenses of FIG. 3a are disposed in such a way that their ends are positioned on the circular arc of the micro-lenses of the lenticular array of FIG. 2a, the mean direction of the facets remains the same as that of the N elementary circular arcs that they replace and at the flat tint distance, the observer sees the same sub-pixel N times, in the form of replicas R₁ to R₈.

Thus, each sub-pixel of the autostereoscopic image may be seen by the viewer in a duplicated and unamplified form, all other things being equal.

It is not necessary for N to be equal to N′, thereby implying that the lenticular array according to the invention is able to display autostereoscopic images having a number N of viewpoints that is less than or much greater than N′.

If N′>N, then each of the N′ facets does not cover an entire sub-pixel, the consequence of which is that the illumination inhomogeneities are more apparent.

If N′<N, then each of the N′ facets corresponds to a sub-pixel, plus an inter-pixel interval and to a fraction of another sub-pixel. In this case, the separating power tends to decrease and therefore the quality of the relief perceived by the viewer.

For N=2, N′ may be for example equal to 2, 3 or 4

For N=3, N′ may be for example equal to 3, 4 or 5

For N=4, N′ may be for example equal to 4, 5 or 6

For N=5, N′ may be for example equal to 5, 6 or 7

For N=6, N′ may be for example equal to 5, 6, 7 or 8

For N=7, N′ may be for example equal to 6, 7, 8 or 9

For N=8, N′ may be for example to 7, 8, 9 or 10.

To summarize, for N greater than or equal to 6, N′ may lie for example between N−1 and N+2, and for N less than 6, N′ may lie for example between N and N+2.

The invention also applies to the case where the lenticular array has its longitudinal axis vertical, that is to say disposed parallel to the columns of pixels.

1. Lenticular array configured to be placed in front of a screen so as to carry out autostereoscopic viewing and comprising lenticules separated by a spacing P and extending in a longitudinal direction and which are joined together via a longitudinal principal join line, characterized in that each micro-lens is comprised of at least N′ contiguous plane faces which are joined together via a longitudinal secondary join line with N′ greater than or equal to 2, each plane face defining in cross-section perpendicular to the said longitudinal direction a straight segment, and in that the ends of the said straight segments are situated on a circular arc centred on a point O situated in the mid-plane of the said micro-lens, or else on a portion of parabola, hyperbola or ellipse with focus (F) situated in the said mid-plane (MP).

2. Lenticular array according to claim 1, wherein the N′ straight segments have the same length.

3. Auto stereoscopic viewing screen, wherein it comprises a lenticular array according to claim 1.

4. Screen according to claim 3, characterized in that N=2 and in that N′=2, 3 or 4.

5. Screen according to claim 3, characterized in that N=3 and in that N′=3, 4 or 5.

6. Screen according to claim 3, characterized in that N=4 and in that N′=4, 5 or 6.

7. Screen according to claim 3, characterized in that N=5 and in that N=5, 6 or 7.

8. Screen according to claim 3, characterized in that N is greater than or equal to 6 and in that N′ lies between N−1 and N+2.
